(19) United States
(12) Patent Application Publication
(10) Pub. No.: US 2012/0186385 A1
(43) Pub. Date: Jul. 26, 2012

(54) COMPOSITION OF MATTER FOR HANDLE BAR GRIPS

(76) Inventor: Peter Holze, Sayville, NY (US)

(21) Appl. No.: 13/014,527

(22) Filed: Jan. 26, 2011

(51) Int. Cl. B62K 21/26

(52) U.S. Cl. 74/551.9

(57) ABSTRACT

An inventive composition of matter for use in handlebar grips such that the handlebar grips permit a rider to experience a natural feel and a more intimate connection to his motorcycle, develop character, age gracefully, enhance the look and aesthetic qualities of the bike. It comprises wood, wood blends, or wood composites.

### BACKGROUND OF THE INVENTION

1. Field of the Invention

The present invention relates to a composition of matter and method for use thereof with handlebars. More particularly, the present invention relates to a new composition of matter comprising wood, for use with handlebar grips designed for use on handlebars of among other things, motorcycles and bicycles.

2. Description of the Prior Art

A motorcycle (hereinafter “bike”) is a two-wheeled vehicle powered by an engine. The wheels are in-line, and at higher speed, the bike remains upright and stable by virtue of gyroscopic forces. At lower speeds, continual readjustment of the steering by the rider gives stability. The rider sits astride the bike on a seat, upright or slightly bent over depending on the bike, with his or her hands out in front on a set of handlebar grips, on a handlebar, mounted at the front end of the bike.

Speed is controlled by a twist throttle on the right side handlebar grip. Braking is controlled with a hand-lever on the right side handlebar grip and right foot pedal (front and rear wheel, respectively). Gear control (shifting) is accomplished by clutch located at the left hand lever. Steering is accomplished by trained application of slight turning of the handlebars and lateral shifting of the rider's weight.

The handlebar can be straight or bent. It is the bike's steering mechanism and together with the rider's balance and center of gravity it steers the bike. Handlebar design is a trade-off between several desirable qualities which include enabling the rider to assume an aerodynamic position, enabling the rider to change body positions during long rides, preventing fatigue and providing necessary leverage to steer the motorcycle.

Handlebar grips provide a surface on opposite ends of a handlebar for the rider to grasp. They allow the user to grasp, hold and support his hands to allow him or her to squeeze and steer. The left side grip gives the user a solid appendage to hold on to while riding a bike. This provides stability, confidence, and control of the steering mechanism, through the handlebar. The right side grip not only provides the same attributes but also facilitates manipulation of throttle control.

For those who ride motorcycles, the richness of their riding experience depends, in part, on how much of a connection they feel to their bike both physically and mentally. One method of achieving a physical connection to the bike is through the handlebar grips. The prior art has attempted to create a more comfortable physical connection between a rider and his or her bike, and a richer riding experience, by creating handlebar grips which consist of more and more technologically advanced materials such as metal alloys, plastics, rubber, polymers, soft rubbers, gels, curable materials and the like, and incorporating air chambers, air cushions, complicated structures and so on. For example:

a) Brilando, U.S. Pat. No. 3,713,350 discloses an air cushion handlebar grip slidable onto handlebar and having lower portion with finger-receiving scallops, side portions with peripherally spaced and longitudinally extending grooves, and upper portion opposite finger-receiving scallops with a longitudinally extending air-containing cavity therein to absorb shocks and prevent pinching of nerves in palmar aspect of hand.

b) Marui, U.S. Pat. No. 4,964,192 discloses a cushioned grip having a unitary tubular-shaped body portion with an asymmetrical off-center cross-sectional shape. The asymmetrical off-center shape provides increased cushioning on portions thereof while retaining a moderate sized circumference. The asymmetrical cross-sectional shape provides a first portion having a first thickness of cushioning material, a second portion having a second lower thickness of cushioning material and a third portion of further reduced thickness of cushioning material. The third portion of cushioning is provided with a flat surface to provide a positive and solid feel to the fingers while grabbing the grip. The center's curvature defined by the outside of the cross-sectional shape of the grip is displaced from the center of the inside portion which is generally circular and adapted to receive a hard round member such as a bicycle handlebar to be cushioned. The cushioning thickness may vary from a relatively small value at one end of the grip to a maximum in a central region and reducing again to a smaller thickness at the other end to provide a varying circumference for different size hands.

c) Olmr, U.S. Pat. No. 4,972,733 discloses a shock absorbing hand grip comprising an inner elongated resilient tubular wall member adapted to slidably receive a supporting structure and an outer concentric resilient elongated tubular wall member spaced from the inner tubular wall member. A plurality of flexible spacer members are disposed between the inner and outer tubular wall members having a first end attached to the inner tubular wall member and a second end attached to the outer tubular wall member. The flexible spacer members are disposed between the inner and outer tubular wall members at an angle to the axial plane of said tubular members so as to create a region of bending flexure for the spacer member between the inner and outer tubular walls such that shock forces applied to one tubular wall member will cause a bending flexure of the spacer members whereby such shock forces are substantially completely displaced in a non-radial direction to the other tubular wall member.

d) Rosenthal, United States Letters Patent Application No. 2004/0093979 discloses a motorcycle handlebar hand grip comprising a hollow cylindrical body having a first, open end and an opposing, second end, which may be open or closed, and an annular flange projecting radially outwards at the first, open end. In order to prolong its useful life as regards wear by a rider's hand, and also improve comfort and vibration damping, the body has an external surface which is formed with projections and which tapers from adjacent the flange to adjacent the second end. The taper is achieved by the projections progressively decreasing in height from adjacent the flange to adjacent the second end. The base area of the respective projections may also progressively decrease in size from adjacent the flange to adjacent the second end.

e) Wu, United States Letters Patent Application No. 2004/0134304 A1 discloses a handlebar grip for bicycle which includes a grip member having a hard base and a soft outer layer. The hard base has a straight tubular body and an upright end portion formed integral with the straight tubular body. The soft outer layer is fixedly fastened to and covered on the surface of the hard base.

f) Chadwick, et. al., United States Letters Patent Application No. 2004/0036194 A1 discloses A grip element having a soft, compressible and deformable outer layer supported by an underlying support structure sufficiently rigid to maintain a receiving channel of the grip element in an open configuration. The support structure facilitates manipulation of the grip element and assembly of the grip element onto a hand-held article without having the outer layer collapse on itself as would occur without the support structure as a result of the soft, deformable nature of the outer layer. The grip element may be formed separately from the hand-held article on which it is to be assembled, and then positioned thereon such that the hand-held article is sold with the grip element pre-assembled thereon. If desired, the grip element may be provided separate from the hand-held article, the outer layer providing a readily compressible and deformable soft cushioning surface and the support structure facilitating insertion of the outer layer over at least a portion of a hand-held article. The outer layer and support structure may be co-molded such that the materials thereof are permanently and directly bonded together. If desired, a pattern may be formed on the outer layer, such as grooves, dimples, ribs, bumps, a lattice pattern, or a honeycomb pattern.

g) International Application Number PCT/GB92/01174 discloses a deformable and curable substance for use on a hand interface. The substance is extruded to a plain or intricate form in order to facilitate deformation of the substance, depending on the particular application. The intricate form has a continuous top interface surface but has hollow sections and legs which project downward to form a comb like profile. The intricate profile may be a short horizontal section, a curve or complete circle. By using a deformable and curable hand interface the user can enjoy the advantages of an exactly tailored imprint of his hand. Normal pressure concentration points of the hand act to disperse the material to achieve better pressure load distribution.

h) International Application Number PCT/IB02/01101 discloses handlebar grips for a bicycle or similar vehicle formed by a main rigid body of tubular shape supporting, fixed thereon, a covering of moderately soft material, in particular in gel form. Two terminal elements are provided at the ends of the grip, each of said elements being provided with an annular protection rim intended to line a corresponding end edge of the covering, and with an elastically deformable tubular lug which is intended to be inserted between the end section of the handlebar and the main body remaining compressed between said elements so as to ensure gripping engagement as a result of friction thereon.

i) International Application Number PCT/US01/29214 discloses a grip element having a soft, compressible and deformable outer layer supported by an underlying support structure sufficiently rigid to maintain a receiving channel of the grip element in an open configuration. The support structure facilitates manipulation of the grip element onto a hand held article without having the outer layer collapse on itself as would occur without the support structure as a result of the soft, deformable nature of the outer layer. The grip element may be formed separately from the hand held article on which it is to be assembled, and then positioned thereon such that the hand-held article is sold with the grip element preassembled thereon. If desired, the grip element may be provided separate from the hand-held article, the outer layer providing a readily compressible and deformable soft cushioning surface and the support structure facilitating insertion of the outer layer over at least a portion of the hand-held article. The outer layer and support structure may be co-molded such that the materials thereof are permanently and directly bonded together. If desired, a pattern may be formed on the outer layer, such as grooves, dimples, ribs, bumps, a lattice pattern, or a honeycomb pattern.

The foregoing and other prior art attempts at comfort notwithstanding, the handlebar grips currently available to riders, suffer from many drawbacks. One such drawback is that the prior art handlebar grips still fail to provide a more intimate and natural riding experience. One of the reasons is that they are all composed of synthetic materials. As a result, the prior art handlebar grips are lifeless, alien-feeling, and barrier-creating instruments. They do nothing to enhance the connection between the riders and their bikes. To the contrary, they create barriers between riders and their bike. Due to their synthetic nature, they have an insulating effect which results in a physical barrier, or a wall between the riders and their bikes so that the rider loses sense of the lifelike aspects of the bike.

The insulating effect of current handle bar grips is further augmented by the use of soft, compressible or air cushioned handlebar-grip construction like those disclosed in U.S. Pat. No. 3,713,350, PCT/US01/29214 and U.S. Pat. No. 4,964,192, because such construction minimizes or suppresses the vibrations created by the bike when it is being operated. This makes it harder for a rider to feel when he or she needs to switch gears and when the engine is not running well. As a result, the physical connection between rider and his or her bike is intermittent or totally non-existent. Therefore, when using any of the above mentioned materials or grips, a rider is unable to truly connect with his or her bike. If the rider is unable to connect with his or her bike, the rider will have a less enjoyable and intimate experience.

Another drawback in the synthetic complex handlebar grips disclosed in the prior art is that thy are not breathable or porous. As a result they do not absorb any of the rider's sweat or natural hand oils. Therefore, when using synthetic handlebar grips, a rider's hands will begin to sweat. This reduces comfort and provides another level of separation between a rider and his or her bike.

Yet another drawback in the synthetic complex handlebar grips disclosed in the prior art is that none of them take up the riders' hand temperature very well. In fact some of the materials, as for example metal alloys, conduct heat away from riders' hands which cause them to get cold. This necessitates that the rider wear gloves when he or she rides, thereby providing yet another barrier between the rider and his or her bike.

Finally, another drawback in the synthetic complex handlebar grips of the prior art is that, they do nothing to enhance the aesthetic qualities of the bike. As both the bike and grips age over time, they deteriorate and lose both their aesthetic and functional properties. For example, metals will rust and tarnish. Rubber will dry out and crack. Plastic will crack and become brittle. Additionally, both rubber and plastic will begin to fade over time. This means that they must be replaced which could present a problem if the bike itself is old. When you put new handlebar grips on an old bike, the look of the bike becomes inconsistent and the aesthetic quality of the bike is diminished.

It is clear then, from the above that none of the prior art discloses any handlebar grips, or a composition of matter for use with handlebar grips, which allow for a more intimate connection between a rider and his or her bike. Moreover, none of the prior art discloses a material or a composition of materials for manufacturing or producing handlebar grips, which contributes to the overall aesthetic appearance and character of the grips, as they age and as they are being used on the bike. Accordingly, there is a need for a composition of matter to use with handlebar grips which will (i) enable the rider to have a natural feel and give the rider a more intimate connection with his or her motorcycle; (ii) allow the handlebar grips to develop character as they age; and (iii) enhance the look and aesthetic qualities of the handlebar grips and the bike upon which they are installed.

### OBJECTS OF THE INVENTION

IT IS THEREFORE AN OBJECT of the present invention to provide handlebar grips which upon installation on a bike, enable the rider of the bike to have a more natural feel and a more intimate connection therewith.

IT IS ANOTHER OBJECT of the present invention to provide handlebar grips which will develop a deeper character and a richer appearance as they age and as they are being used on the handlebars of a bike.

IT IS YET ANOTHER OBJECT of the present invention to provide handlebar grips which will enhance the look and aesthetic qualities of the bike.

IT IS STILL ANOTHER OBJECT of the present invention to provide a composition of matter for producing handlebar grips, which will allow for a more intimate connection between a rider and his or her bike on which the handlebar grips are installed.

IT IS A FURTHER OBJECT of the present invention to provide a material or a composition of materials for manufacturing or producing handlebar grips, which become more aesthetically pleasing and/or acquire character, as they age and as they are being used on the bike.

These objects, as well as other objects and advantages will become more apparent in the description that is set forth herein below, particularly when read in conjunction with the accompanying drawings.

### SUMMARY OF THE INVENTION

The illustrative embodiments of the present inventive composition of matter for use during the production of handlebar grips, result in handle bar grips that permit a rider to experience a natural feel and a more intimate connection to his or her motorcycle. They also provide a rider with handlebar grips which upon installation on the rider's bike, will develop character, age gracefully and enhance the look and aesthetic qualities of the bike, with the passing of time.

The present inventive composition of matter for use with handlebar grips comprises wood and wood blend composites.

The inventive device, wooden handlebar grips, is a handlebar grip comprising wood. The inventive wooden handlebar grips can be made of any type of wood, now known or later discovered by man.

### BRIEF DESCRIPTION OF THE DRAWINGS

While the specification concludes with claims which particularly point out and distinctly claim the present invention, it is believed that the present invention will be better understood from the following detailed description taken in conjunction with the accompanying drawings in which like numerals represent identical elements and wherein:

FIG. 1 is a prospective view of the present inventive wooden handlebar grips;

FIG. 2 is an exploded view of the present inventive wooden handlebar grips, being slidably mounted to a motorcycle handlebar;

FIG. 3A is an exploded, longitudinal cross sectional view of the present inventive wooden handlebar grips, showing the longitudinally extending bore as it slidably attaches to handlebars. It also shows the present inventive wooden handlebar grips with a closed off outer end;

FIG. 3B is a longitudinal cross sectional view of the present inventive wooden handlebar grips, showing the longitudinally extending bore and an outer end provided with a reduced opening;

FIG. 4 is a photograph of one embodiment of the inventive wooden handlebar grips comprising Indian rosewood;

FIG. 5 is a photograph of another embodiment of the inventive wooden handlebar grips comprising sapele wood; and

FIG. 6 is a photograph of yet another embodiment of the inventive wooden handlebar grips comprising oak.

LIST OF ELEMENTS AND THEIR RESPECTIVE
IDENTIFYING NUMERALS

| NO | ELEMENT |
|---|---|
| 10 | Motorcycle handlebars |
| 20 | Inventive wooden handlebar grips |
| 22 | Outer end or first end of tubular wooden body |
| 24 | Inner end or second end of tubular wooden |
| | body |
| 26 | Longitudinally extending bore or cavity |
| 28 | Hand confining flanges |
| 30 | Finger receiving scallops |
| 32 | Peripherally spaced grooves |

### DETAILED DESCRIPTION OF THE INVENTION

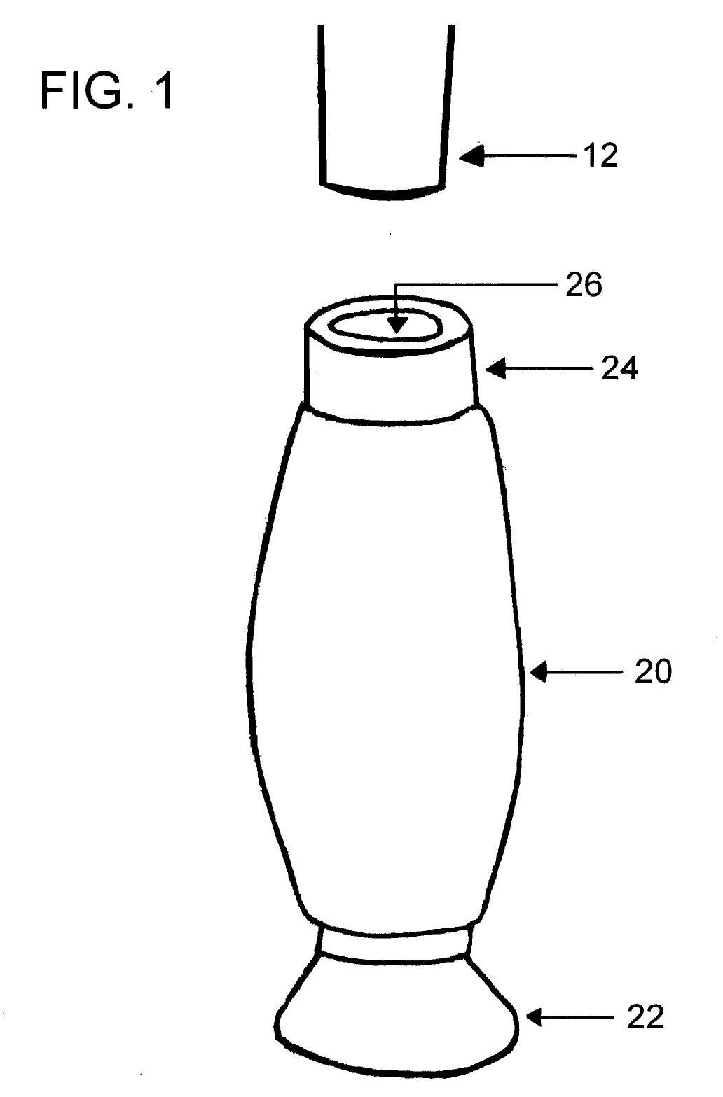

Referring more specifically to the drawings, FIG. 1 generally depicts the inventive device, 20, i.e., wooden handlebar grips. They are designed to (i) provide the rider with more natural feeling handlebar grips; (ii) give the rider a more intimate connection to his or her motorcycle; (iii) develop character as they age; and (iv) enhance the look and aesthetic qualities of the bike.

As set forth herein above, a motorcycle is a two-wheeled vehicle powered by an engine. The wheels are in-line, and at higher speeds, the bike remains upright and stable by virtue of gyroscopic forces. At lower speeds, continual readjustment of the steering by the rider gives stability. The rider sits astride the bike on a seat, with his hands on a set of handlebar grips, on a handlebar mounted at the front end of the bike.

Speed is controlled by a twist throttle on the right side handlebar grip. Braking is controlled with a hand-lever on the left side handlebar grip and foot pedal (front and rear wheel, respectively). Gear control (shifting) is accomplished by clutch located at the left hand lever. Steering is accomplished by trained application of slight turning of the handlebars and lateral shifting of the rider's weight.

The handlebar can be straight or bent. It acts as a steering mechanism for bicycles and motorcycles and is used in conjunction with a rider's balance and center of gravity to steer the motorcycle. Handlebar design is a trade-off between several desirable qualities which include enabling the rider to assume an aerodynamic position, enabling the rider to change body positions during long rides, preventing fatigue and providing necessary leverage to steer the motorcycle.

Handlebar grips provide a surface on the both ends of a handlebar for the rider to grasp. They allow the user to grasp, hold and support his hands to allow him or her to squeeze and steer. The left side grip gives the user a solid appendage to hold on to while riding a bike. This provides stability, confidence, and control of the steering mechanism. The right side grip provides these same attributes and, also facilitates manipulation of throttle control.

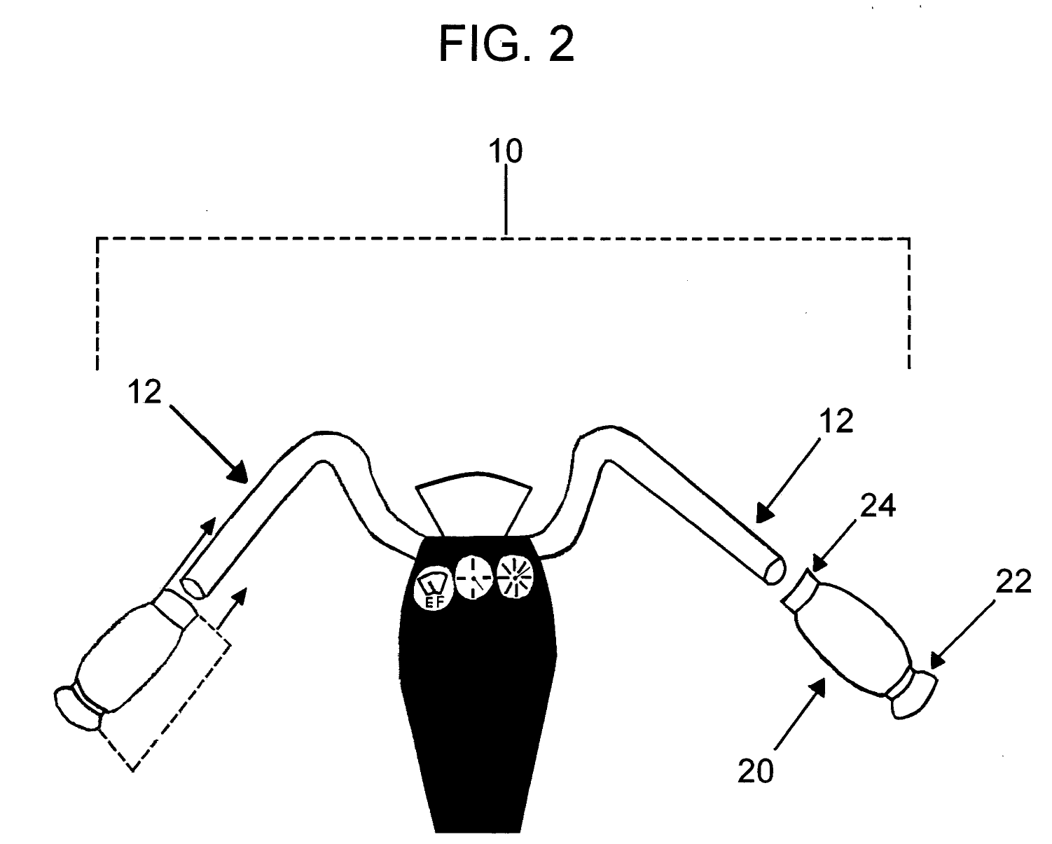

The inventive, wooden handlebar grips 20, as can be seen in FIG. 1 and FIG. 2, are meant to be used on handlebars 10, which have outer ends 12. Said inventive wooden handlebar grips 20, consist of a wooden body having a first or outer end 22, a second or inner end 24, and a centrally located, longitudinal, partially or fully extending bore or cavity 26. Said longitudinally extending bore or cavity 26 further comprises an opening or mouth concentrically aligned with the second or inner end 24 of the handle bar grip 20 and a diameter which is configured and dimensioned in such a manner that when the outer end 12 of the handlebar 10 is inserted into mouth of the bore or cavity 26 of the handlebar grip 20, the wooden handlebar grip 20 can be slidably, frictionally, fixedly but removably mounted upon the outer ends 12 of the handlebar 10.

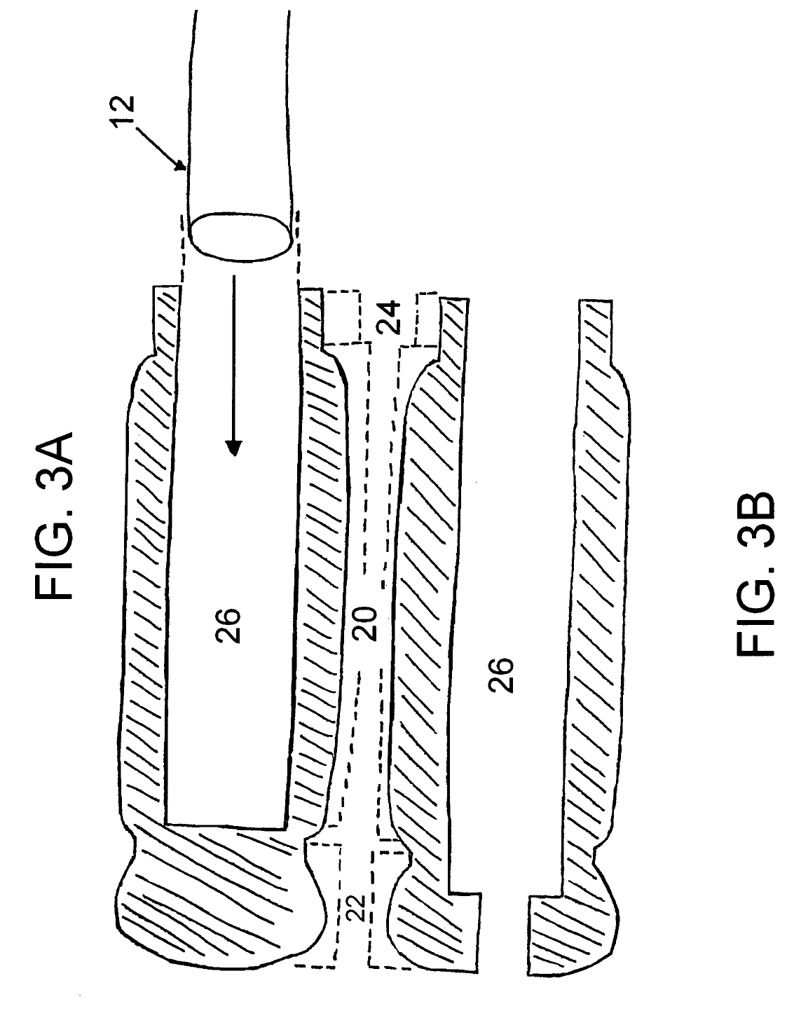

Optionally the inner bore or cavity 26 could be equipped with a metal sleeve, such as for example an aluminum sleeve. Additionally, the inner walls of the longitudinally extending bore 26 may be provided with an adhesive to fix the metal sleeve therein and further facilitate its mounting onto the outer ends of the handlebar 10. Further, as can be seen in FIGS. 3(a) and 3(b), the first or outer end of the tubular wooden body 22 can be sealed or closed as shown in FIG. 3a, or the outer end of it can be provided with a reduced opening as shown in FIG. 3b.

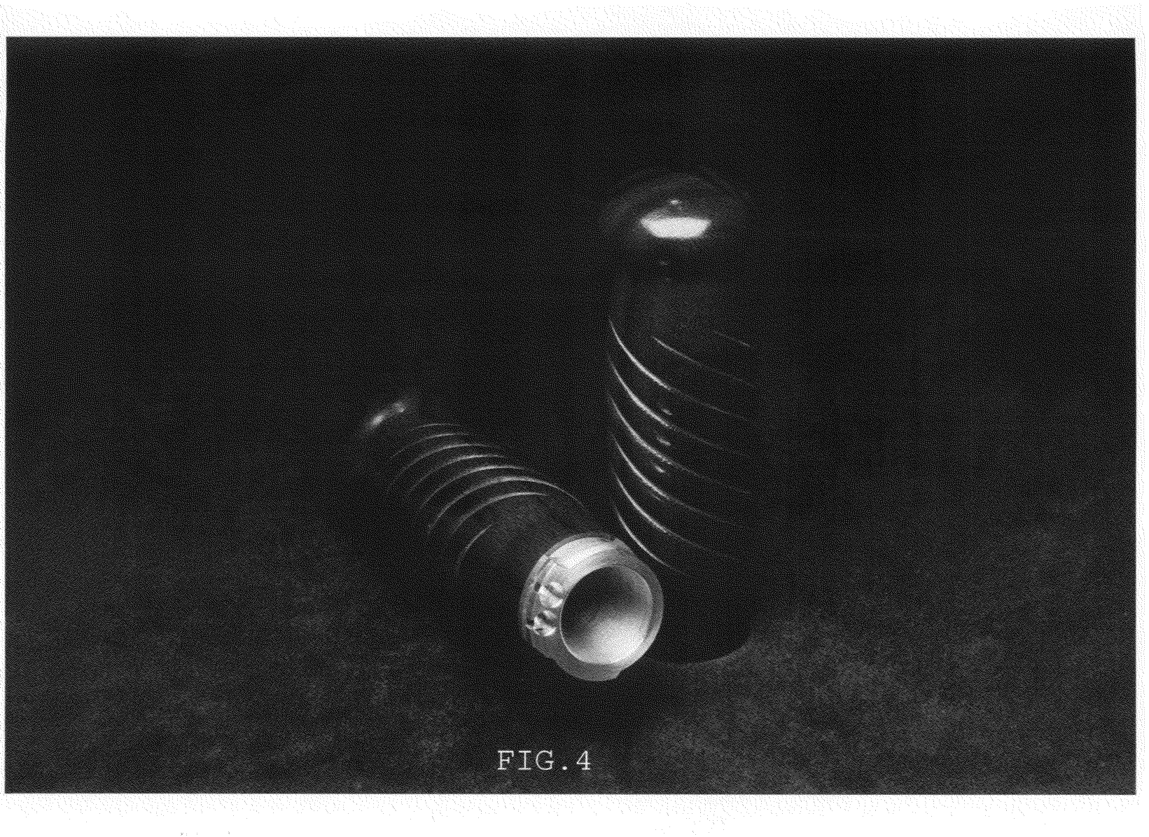

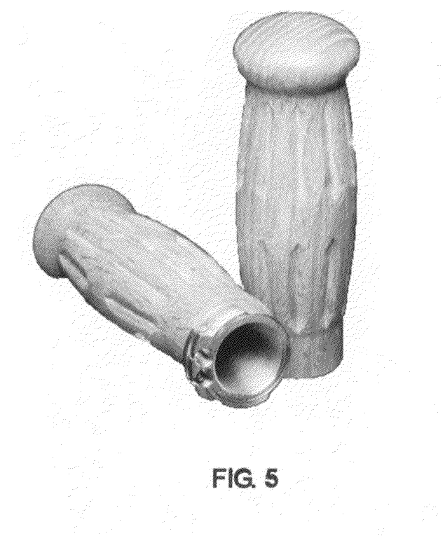

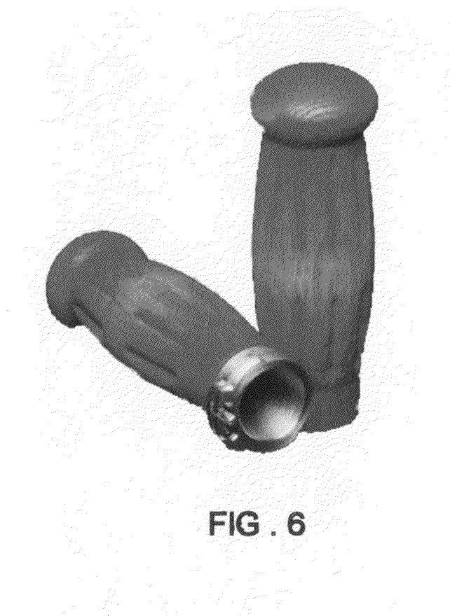

The outer surface of the tubular wooden body of the inventive wooden handle bar grip 20, as can be seen from FIGS. 4-6 can be shaped in any way, or provided with any design, so long as that shape or design does not detract from the ability of the handlebar grip 20 to be slidably, frictionally, fixedly but removably mounted upon the outer ends 12 of the handlebar 10.

FIGS. 4-6 are non-exhaustive illustrations of all the handlebar grip 20's possible embodiments. Referring to FIG. 3, said tubular wooden body's outside surface can be perfectly straight. In another embodiment, said tubular wooden body can have a slight curve to it. In an additional embodiments, the tubular wooden body outer surface can be straight and have hand confining flanges, 28, at each end. In a further embodiment, the tubular wooden body could have a plurality of finger-receiving scallops, 30, spaced longitudinally along its outer surface.

In yet another embodiment, said tubular wooden body could be provided with a plurality of peripherally spaced grooves, 32, extending longitudinally or vertically along the outer surface from one end of said body to the other.

The inventive wooden handlebar grips 20 can be constructed of any known type of wood, wood blend, or wood composite. In the event that a new type of wood is discovered, the wooden handlebar grips, 20, can be composed of that newly discovered type of wood, as well. Such wood includes but is not limited to the wood is selected from the group of wood consisting of Abura, Afara, Afromosia, Afzelia, Agba, Alder, Alstonia, Andiroba, Andoung, cedar, pine, oak, poplar, douglas fir, Antiaria, Asanfona, Ash, Apple, Ayan, Balau, Balsa, Basralocus, Beech, Red Berlinia, Bintagnor, Binuang, Birch, Black Bean, Black Locust, Blackbutt, African Blackwood, Blue Gum, European Boxwood, Bubinga Minor, Caimito, Canarium, American Cedar, Pencil Cedar, Western Red Cedar, Celtis, European Cherry, Horse Chestnut, Sweet Chestnut, Chontaquiro, Coigue, Cordia, Cottonwood, Curupay, Dafo, Dahoma, Danta, Denya, Durian, Ebony, Ekki/Azobe/Kaku West, Elm, Douglas Fir, Silver Fir, Freijo, Fromager, Gmelina, Gombe, Greenheart, Guarea, Western Hemlock, Hickory, Holly, Hornbeam, Hyedua, Idigbo/Emeri/Framire, Ilomba, Imbuja, Ipe Peroba/Ipe de Campos, Iroko/Odum/Mvule, Izombi, Jarrah, Jelutong, Jequtiba, Kapur, Karri, Kauvula, KempasUses, Keruing/Yang/Curju, Khaya, Kokoti, Kosipo/Omu, Koto, Kussia, Larch, Latandza, Lati, Laurel, Lignum Vitae, Limbali, Lime, Longui, Louro, Mahogany, Brazilian Mohogany, Makarati, Makore, Mansonia, Maple, Mashonate/Guariuba, Medang, Mengkulang, Red Yellow and white Meranti/Seraya, Pacific Merbau, Mersawa, Mora, Muhimbi, Muhuhu, Muninga, Mutenye, Niangon, Niove, Nyatoh, Oak, Tasmanian Oak, Odoko, Ogea, Okoume, Okwen, Olon, Opepe/Kussia, Padauk, Panga Panga, Pau Marfim, Pear, Peroba Rosa, Persimmon, Pine, Parana Pine, Pitch Pine, European Plane, Poplar, Purpleheart, Quaruba, Ramin, Rauli, Rosewood, Rubberwood, Sapele, Sepetir, Red Sequioa, Simpoh, Spruce/Whitewood, Red Sterculia, Swamp Sepetir, Sycamore, Tali, Tatajuba, Taun, Tchitola, Teak, Rhodesian Teak, Terentang, Tiama/Edinam/Cedu Nohor, tornillo, Tulipwood/American Poplar, Utile/Sipo, Virola, Vitex Minor, Wallaba, Walnut, Wawa/Samba/Obeche/Aous, Wenge, Willow, Yew.

The process of making the inventive wooden handlebar grips comprises the following steps:
a. Securing wood having a moisture content of anywhere from 6% to 8%. If the moisture of the wood is higher, then the wood cannot be used. Securing wood with that low a moisture content is difficult, because wood is a cellulose based, porous, natural material which tends to absorb moisture or water rather quickly. Thus, not all woods are necessarily right for making the inventive handlebar grips and those that are many times need to be kiln dried to reduce the moisture to the proper content;
b. Optimizing the wood for defects, to remove knots and whatever other defects are visible to the naked eye;
c. Squaring the wood to S4S through a four head molder;
d. Precision end trimming and cutting the length of the wood;
e. Optimizing the wood for defects a second time;
f. Cutting the wood to the finished turning length. The wood produced at this point has the grain of the wood running along the length of the wood;
g. Securing the wood in a drilling or boring machine and drilling the wood end grain, to very high tolerances, to create the inner bore or cavity 26. This is quite difficult to do, particularly when using hardwoods which are very dense to drill. As a result, the bore or cavity drilled can wander off center, if a defect in the wood such as a knot or an irregularity is encountered during the drilling process. If the cavity or bore wanders off center due to a defect, the bore is drilled at an angle, and the hole or mouth of the cavity is not fully centered and concentric with the inner or second end 24 resulting in a partially formed handlebar grip that is not usable and therefore must be discarded;
h. thereafter, plugging the bore of the wood with a plug, securing the bored, plugged wood between the drive center and the tail center of a 4-axis lathe, as for example a 4-axis CNC lathe, and initiating and completing the process of removing the wood on the outside surface of the handlebar grip in stages, until the outer surface is roughed to the desired appearance;
i. removing the roughed and bored handlebar grip from the 4-axis lathe; and
j. treating the wood with sealant to prevent the absorption of moisture so that the handlebar grips withstand the weather and remain true to the strict tolerances required for handlebar grips, by regulation, in the motorcycle industry. To this end, optionally, the internal bore of the handlebar grips could be fixedly fitted with a metal sleeve, preferably an aluminum sleeve.

Working with wood to make the inventive handlebar grips is a very difficult and expensive process. First of all wood tends to crack. Being that it is a natural material made of cellulose it comprises many defects, as for example knots and such. This means that when working with wood, cracking is a real possibility. As a result sometimes the desired result is achieved and sometimes it is not. One has no way of knowing whether the final result is achievable or not, and will not be able to make that determination until one actually starts working with the wood. As a result, working with wood includes a huge waste factor, which contributes to high costs of production, and makes it a highly undesirable material to work with.

Further, the regulation standards and specifications for handlebar grips are extremely tight. This means that the precision tolerances for the production of wood handlebar grips must also be very, very tight. However, it is very hard to keep to those tolerances because wood tends to expand and contract and as a result it changes the tolerances of the item. When that happens one can neither retool nor regrind. As a result the item must be discarded, further adding to the overall cost of production. In fact, during the production of wood handlebar grips at least one third (⅓) of the wood is wasted or discarded making the whole process extremely expensive and cost prohibitive.

The foregoing notwithstanding, it has been determined after repeated attempts, that making the handlebar grips out of wood imparts properties to the handlebar grips that heretofore have never been experienced in the motorcycle industry. Wood has a more natural feel because it comes from a source that was once living. Thus, it feels more comfortable and more alive. It adapts more quickly to body temperature than synthetic materials. As a result, the inventive handlebar grips equilibrate to the temperature of the particular rider's hands quickly, giving the handlebar grips a much more natural feel and allows the rider to be more in tune with their bike.

By comparison to metal, rubber, and other synthetic materials, wood has a natural cell structure. This cellular structure allows moisture and other compounds to move in and out of the cell walls and cell membranes. Compounds like those that compose the oils from a rider's hands, as well as water from a rider's sweat, can move in and out of the cells of the wood. This causes the grips to expand and contract in response to the rider's hand temperature and level of perspiration. In addition, it lessens the risk of the riders hands slipping and thus affords a greater deal of safety and comfort than metal or plastic. It also brings a rider closer to his bike by eliminating the need for gloves. Thus, a rider can actually touch the bike with his own skin instead of through the artificial medium of plastic, rubber, leather and metal.

As a result, wooden handlebar grips give a rider an almost spiritual connection to his or her machine that is unavailable through use of any other material. It bridges the gap between man and machine through an experience that only wood can provide. This type of connection cannot be replicated by the synthetic feeling of plastic or rubber nor can it be replicated by the cold harshness of metals. As a result, the rider can develop a more intimate connection with his or her bike.

Furthermore, under the influence of the elements to which wooden handlebar grips are exposed, the wood ages in a way which is more akin to the way humans age. It develops more character and takes on a more distinguished look. It becomes slightly darker or lighter, and the grains of the wood become more defined. As a result, as the handlebar grips age, they need not be replaced as they enhance the esthetic quality of the bike itself by taking on a more distinguished character.

In contrast, synthetic materials fall apart, fade, tarnish, dry out, crack, and rust as they age. Wood on the other hand, actually ages along with its rider as it gets used more and more. Thus, the look and feel of the handlebar grips will be different based upon who rides and/or owns the bike. In a sense, each set of wooden handlebar grips will have their own physical story to tell. Over time, the wooden handlebar grips begin to represent the rugged simplicity that is in itself the essence of motorcycling.

Combining wood with a modern manufactured machine is a total contradiction; just like riding and connecting to a bike is a contradiction. Nonetheless, natural beauty creates such a compliment to the modern motorcycle, which elicits visions of horses being ridden into the sunset and emotions of power, and freedom, bucking the system and returning to an older and simpler time.

Finally, as a result of the fact that the wooden handlebar grips are made of wood they can be custom made and built to order. This allows the wooden grips to be further tailored to a rider's individual preferences. Therefore, it brings the motorcycle industry closer to its goal of providing a spiritual connection between rider and his or her motorcycle.

There is no question from the foregoing that the inventive handlebar grips 20's composition described herein above, accomplishes all of its objectives and achieves the goal of providing handle bar grips which: 1) upon installation on a bike, will enable the rider of the bike to have a more natural feel of and a more intimate connection therewith; 2) will develop a deeper character and a richer appearance as they age and as they are being used on the handlebars of a bike; 3) which will enhance the look and aesthetic qualities of the bike; 4) will allow for a more intimate connection between a rider and his or her bike on which the handlebar grips are installed; and 5) will become more aesthetically pleasing and/or acquire character, as they age and as they are being used on the bike.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, we claim:

1. A handlebar grip comprising wood.

2. The handlebar grip according to claim 1 wherein the wood is selected from the group of woods consisting of Abura, Afara, Afromosia, Afzelia, Agba, Alder, Alstonia, Andiroba, Andoung, cedar, pine, oak, poplar, douglas fir, Antiaria, Asanfona, Ash, Apple, Ayan, Balau, Balsa, Basralocus, Beech, Red Berlinia, Bintagnor, Binuang, Birch, Black Bean, Black Locust, Blackbutt, African Blackwood, Blue Gum, European Boxwood, Bubinga Minor, Caimito, Canarium, American Cedar, Pencil Cedar, Western Red Cedar, Celtis, European Cherry, Horse Chestnut, Sweet Chestnut, Chontaquiro, Coigue, Cordia, Cottonwood, Curupay, Dafo, Dahoma, Danta, Denya, Durian, Ebony, Ekki/Azobe/Kaku West, Elm, Douglas Fir, Silver Fir, Freijo, Fromager, Gmelina, Gombe, Greenheart, Guarea, Western Hemlock, Hickory, Holly, Hornbeam, Hyedua, Idigbo/Emeri/Framire, Ilomba, Imbuja, Ipe Peroba/Ipe de Campos, Iroko/Odum/Mvule, Izombi, Jarrah, Jelutong, Jequtiba, Kapur, Karri, Kauvula, KempasUses, Keruing/Yang/Curju, Khaya, Kokoti, Kosipo/Omu, Koto, Kussia, Larch, Latandza, Lati, Laurel, Lignum Vitae, Limbali, Lime, Longui, Louro, Mahogany, Brazilian Mohogany, Makarati, Makore, Mansonia, Maple, Mashonate/Guariuba, Medang, Mengkulang, Red Yellow and white Meranti/Seraya, Pacific Merbau, Mersawa, Mora, Muhimbi, Muhuhu, Muninga, Mutenye, Niangon, Niove, Nyatoh, Oak, Tasmanian Oak, Odoko, Ogea, Okoume, Okwen, Olon, Opepe/Kussia, Padauk, Panga Panga, Pau Marfim, Pear, Peroba Rosa, Persimmon, Pine, Parana Pine, Pitch Pine, European Plane, Poplar, Purpleheart, Quaruba, Ramin, Rauli, Rosewood, Rubberwood, Sapele, Sepetir, Red Sequioa, Simpoh, Spruce/Whitewood, Red Sterculia, Swamp Sepetir, Sycamore, Tali, Tatajuba, Taun, Tchitola, Teak, Rhodesian Teak, Terentang, Tiama/Edinam/Cedu Nohor, tornillo, Tulipwood/American Poplar, Utile/Sipo, Virola, Vitex Minor, Wallaba, Walnut, Wawa/Samba/Obeche/Aous, Wenge, Willow, Yew

3. A handlebar grip comprising a wood blend.

4. A handlebar grip comprising a wood composite.
